(19) United States
(12) Patent Application Publication
(10) Pub. No.: US 2008/0217304 A1
(43) Pub. Date: Sep. 11, 2008

(54) MEDICAL IMPLANT AND METHOD FOR THE PRODUCTION THEREOF

(76) Inventor: Jan LITZKE, Berlin (DE)

Correspondence Address: Intellectual Property Department;DEWITT ROSS & STEVENS S.C., 6th Floor, 2 E. Mifflin St., Madison, WI, 53703, US

(21) Appl. No.: 12/043,274

(22) Filed: Mar. 6, 2008

(30) Foreign Application Priority Data
Mar. 6, 2007 (DE) 10 2007 011 310.4

(51) Int. Cl. B23K 10/02

(52) U.S. Cl. 219/121.46

(57) ABSTRACT

A medical implant such as a cardiac pacemaker or a defibrillator is assembled from a first element and a second element, which each have a surface. The first element and the second element are connected to one another in a joining step in the particular connection area of the first element and of the second element which forms at least a partial area of the particular surface. In a plasma activation step to be performed before the joining step, at least the connection area of the first element and/or at least the connection area of the second element is activated in a low-pressure plasma or in a plasma generated at atmospheric pressure.

### FIELD OF THE INVENTION

The present invention relates to a method for producing a medical implant, preferably a cardiac pacemaker or a defibrillator, comprising a first element and at least one second element, which each have one surface, the first element and the at least one second element being connected to one another in a joining step in the particular connection areas of the first element and the second element which form at least a partial area of the particular surface. The present invention additionally relates to a corresponding medical implant.

### BACKGROUND OF THE INVENTION

Medical implants have the object of supporting or replacing bodily functions. They are also referred to as (implantable) prostheses depending on their function. Frequently used medical implants are, for example, cardiac pacemakers, defibrillators, brain pacemakers, cardiac implants, implants for operative treatment of bone fractures, or stents.

Implants of this type are usually assembled from multiple elements during their production. In particular, the joining methods of assembly, filling, pressing on and press fitting, welding, soldering, and gluing as well as the methods of screwing, riveting, clinching, and shrinking are suitable as joining methods for these elements for producing a medical implant. The state of the surface of the particular elements to be joined in the partial area in which the elements are joined (referred to in the following as the connection area) is significant for joining methods of this type, in particular for gluing, to ensure optimum strength of the joint connection and the seal in relation to bodily fluids.

The treatment of surfaces in the field of medical implants is known from the document U.S. Pat. No. 6,101,973. The method presented therein is used for the purpose of improving the sliding properties of polymer surfaces. In this document, in particular surfaces of tubing materials, such as silicone, polypropylene, polyethylene, polyvinyl chloride, fluoropolymer, or other dielectric materials are claimed. The document describes that an improvement of the sliding properties of the surface of the tubing material may be achieved in that the material is treated using a corona discharge in a plasma, the corona discharge being connected to the application of a monomer. For this purpose, the tubing material may be treated in a pretreatment zone using a further corona discharge before the application of the monomer to prepare the tubing material for the application of the monomer in a following zone. For example, saturated cyclic groups, amine groups, hydroxyl groups, carbonyl groups, etc. are used as monomers. An especially preferred monomer is N-vinyl-2-pyrrolidone (NVP). The method specified in U.S. Pat. No. 6,101,973 is very complex and is not applicable for preparing the joints of elements of medical implants, because, for example, the adhesive effect of an adhesive used for the joining is reduced by the improved sliding capability of the surface and the strength of the connection would be negatively influenced in this way.

Elements of medical implants, e.g., parts of a cardiac pacemaker, have been mounted predominantly by hand up to this point and subsequently glued partially automatically using silicone or other adhesives. This method is unstable and very complex and requires an array of post-processing steps, e.g., polishing. In the adhesive method, for example, areas may arise due to irregular adhesive application, by which a reduced seal or short-circuits at the terminals may be caused in the area of the adhesive bond.

### SUMMARY OF THE INVENTION

The object of the present invention is accordingly to specify a method for producing a medical implant, which requires less post-processing and in this way ensures lower processing times and higher processing reliability. The object is further to provide a medical implant which is more cost-effective to produce and has a lower susceptibility to error.

This object is achieved according to the present invention by a method of the type cited at the beginning for producing a medical implant, in which, in a plasma activation step to be performed before the joining step, at least the connection area of the first element and/or at least the connection area of the at least one second element is activated in a low-pressure plasma or in a plasma generated at atmospheric pressure (normal-pressure plasma).

The low-pressure plasma and/or the plasma generated at atmospheric pressure is an ionized gas in each case, which contains a noticeable proportion of free charge carriers (ions or electrons). The low-pressure plasma is generated at a pressure of approximately 0.1 millibar to 1 millibar and the plasma generated at atmospheric pressure is generated at a pressure of approximately 0.5 bar to 8 bar.

The plasma is generally generated in that a high electrical voltage is applied in a gas between two electrodes. With a suitable combination of voltage, electrode interval, and gas pressure, there is a flashover and the ignition of a discharge between the electrodes. In this way, particles ionized by impact ionization are generated, which are incident on their path to the electrode on an element situated in the plasma, in this case an element of a medical implant. In this way, polar groups are generated or incorporated on the surface of the implant and/or the surface is cleaned. The treated surface of the element is thus activated, i.e., the surface has a higher surface energy after the plasma activation. If necessary, the gas particles contained in the plasma may also be enriched on the surface of the element. The surface is pretreated and/or prepared for a joining process in this way. This pretreatment has the result that the subsequent joining process may be designed in an improved and/or more stable way. This causes the processing time for the production of a medical implant to be reduced, because fewer post-processing steps are necessary. In addition, a higher processing reliability is achieved for the joining.

The advantage of plasma activation in low-pressure plasma is additionally that this plasma is creeping, i.e., this plasma also allows undercuts to be activated.

The surface of the first element and of the at least one second element especially preferably has plastic, which is preferably selected from one or more polymers of the group polyurethane, polycarbonate, polyester, polyether, polyolefin, in particular polyethylene and polypropylene, polyvinyl chloride (PVC), polystyrene, and/or a metallic material, which is preferably selected from one or more metallic materials of the group titanium, aluminum, stainless steel, preferably 316L and 316LVM, cobalt-nickel alloy, preferably MP35N, silver, gold, platinum, iridium, niobium, L 605, and/or a ceramic material, preferably aluminum oxide. These materials have been proven to be especially suitable for use in the human body in connection with the production of medical implants.

In a preferred exemplary embodiment of the present invention, the joining step contains a gluing step, epoxide resin or silicone preferably being used as the adhesive. Gluing is an especially simple joining step, which results in a permanent solid bond, which is sealed to gases or bodily fluids if a suitable adhesive is used.

In a further especially preferred exemplary embodiment of the present invention, the first element and the at least one second element are welded and/or mounted to one another before the joining step and the plasma activation step. For example, electrically conductive terminals of the first element and the at least one second element may be connected to one another by welding. During mounting, for example, by using rods or pins on one element and corresponding openings on the other element, a friction-locked and/or formfitting preconnection may be achieved between the elements, so that the elements are already situated in the correct position to one another before the joining and the plasma activation step. In this way, the subsequent plasma activation step and above all the joining step are made easier.

For the plasma activation step, the plasmas which contain at least one element or one compound of the group oxygen, hydrogen, argon, nitrogen, ammonia, and fluorine have been proven to be especially suitable plasmas.

The plasma of the plasma activation step is preferably driven at a frequency of approximately 5 kHz to approximately 100 kHz or at a frequency of 13.56 MHz or 2.45 GHz. Furthermore, the plasmas used for the plasma activation step preferably have a power of approximately 1 W to approximately 1000 W. The treatment time of the element(s) treated in the plasma is preferably approximately 10 seconds to approximately 30 minutes. In this time, on one hand, sufficient activation of the surface is achieved and, on the other hand, too much erosion of the surface is prevented.

To exploit the activation of the surface of the element(s) performed in the plasma optimally, the joining step must preferably be started from at earliest approximately 15 seconds to at latest approximately 300 minutes after the plasma activation step.

Especially preferably, at least a partial area of the connection area of the first element and/or the at least one second element is cleaned in a plasma cleaning step using a plasma generated at atmospheric pressure (normal-pressure plasma) immediately before the plasma activation step. This method step may also be referred to as plasma etching. This additional step is particularly advisable if parts of the elements to be connected to one another, such as electrically conductive terminals of the housing and the header of a cardiac pacemaker, were welded to one another before the plasma activation step. Soot arises during welding, for example, by combustion of grease which has accumulated on the surface. This soot may result in flashovers between the printed conductors and destroy the electronics connected to the terminals in this way. To avoid these consequences, this soot or other surface deposits may be removed using the plasma cleaning step, which may be performed in a locally limited way.

In a preferred exemplary embodiment of the present invention, the plasma cleaning step is performed in a plasma which contains oxygen and/or fluorine.

The erosion of material in the plasma cleaning step is preferably limited in that the treatment time of the element(s) treated in the plasma during the plasma cleaning step is at most approximately 15 minutes.

The plasma of the plasma cleaning step is preferably driven in a frequency of 27.2 MHz or at a frequency of 2.45 GHz.

Especially preferably, the first element is the header and the second element is the housing and/or the second element is the cover of the cardiac pacemaker. The header is a name for an element of the cardiac pacemaker which forms the connection head. The header is used for plugging the electrode(s) into the corresponding plug receptacle(s) and for connecting the electrode(s) to the housing. For this purpose, the header has (a) corresponding terminal(s). The housing contains the batteries of the cardiac pacemaker on one hand and the electronic units for transmitting and processing the data from the heart measured using the electrode(s) and for calculating the pulses to be transmitted by the electrode(s) to stimulate the heart on the other hand. After the connection of the header to the housing, the electronic units of the housing are electrically connected to the ends of the electrode(s). For this purpose, the housing has (a) terminal(s), which is/are connected to the corresponding terminal(s) of the header. The cover is used for covering and sealing the plug receptacle(s) of the header.

The following method is preferably applied according to the present invention in regard to the production of the cardiac pacemaker from the elements cover, header, and housing:
a) firstly, the header and the cover are individually subjected to the plasma activation step,
b) subsequently, the header and the cover are mounted and then glued to one another in a first joining step,
c) the unit made of header and cover is now mounted on the housing, the terminal(s) of housing and header is/are welded to one another and subsequently housing and header are glued to one another in a second joining step.

A method in which
d) firstly the header and the cover are mounted with one another and subjected to the plasma activation step as mounted unit,
e) the header and the cover are subsequently glued to one another in the first joining step,
c) the unit made of header and cover is now mounted on the housing and the terminal(s) of housing and header is/are welded to one another and subsequently housing and header are glued to one another in the second joining step has also proven to be advantageous.

Furthermore, a method is preferably applied in which
d) firstly the header and the cover are mounted with one another and subjected to the plasma activation step as a mounted unit,
e) the header and the cover are subsequently glued to one another in the first joining step,
f) the unit made of header and cover is now mounted on the housing and the terminal(s) of housing and header is/are welded to one another and
g) the unit made of housing and header is subsequently subjected with cover to a further plasma activation step and
h) then glued to one another in the second joining step.

In the last-mentioned method, it has proven to be advantageous if the housing and the header are subjected to an additional plasma cleaning step in the area of the welded terminals before step g) and after step f).

The cleaning procedure reduces later work caused by soot residues and improves the security from voltage flashovers between the live components of the external wiring and the feed through.

In the method according to the present invention, it is additionally possible to subject one element or multiple elements to a plasma activation step or a plasma cleaning step multiple times.

The above object is additionally achieved by a medical implant which is produced according to one of the methods specified above. A medical implant of this type is distinguished in that it may be produced cost-effectively and its susceptibility to error is reduced.

Further goals, features, advantages, and possible applications of the present invention result from the following description of exemplary embodiments on the basis of the figures. All features described and/or illustrated in the figures form the subject matter of the present invention alone or in any arbitrary combination, independently of their combination in the individual claims or what they refer back to.

### BRIEF DESCRIPTION OF THE DRAWINGS

FIG. 1 schematically shows a housing of a cardiac pacemaker in a view from the side,

FIG. 2 schematically shows a header of a cardiac pacemaker in a view from the side,

FIG. 3 schematically shows a cover for two plug receptacles of the header in a view from above,

FIG. 4 schematically shows the configuration of the header from FIG. 2 and a cover from FIG. 3 in a plasma activation device,

FIG. 5 schematically shows the header from FIG. 2 provided with the cover from FIG. 3 in a view from the side,

FIG. 6 schematically shows a unit made of header and cover from FIG. 5 and the housing from FIG. 1 in a view from the side,

FIG. 7 schematically shows the configuration of a unit from FIG. 6 in a plasma activation device, and

FIG. 8 schematically shows the configuration of unit from FIG. 6 in a device for performing the cleaning step.

### DETAILED DESCRIPTION OF PREFERRED VERSIONS OF THE INVENTION

In the following, the method according to the present invention for producing a medical implant will be described on the basis of the example of the production of a cardiac pacemaker having the elements housing 10, header 20, and cover 30.

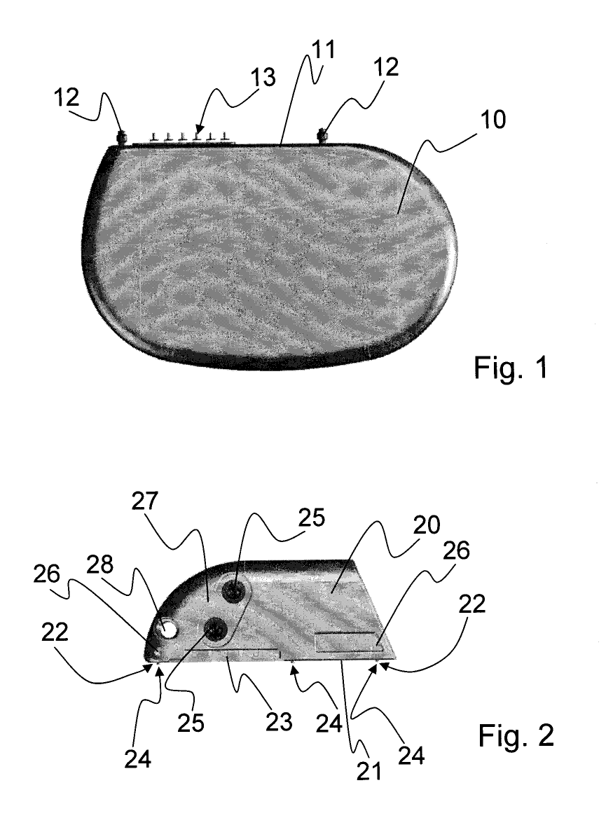

The housing 10 is illustrated in FIG. 1 and has a flat, approximately oval shape. It is provided with a linear edge 11 on its top side. This edge 11 is provided for situating a header 20 and has two pin-shaped, cylindrical rods 12, which are each situated at diametrically opposite ends of the edge 11. These pin-shaped rods 12 are used for mounting the header 20. For this purpose, they have a section enlarged in diameter in their middle section, which is delimited from the sections lying above and beneath by a step in each case.

In addition, six terminals 13 are provided on the edge 11, which are used for an electrical connection to corresponding terminals of the header 20. In further exemplary embodiments according to the present invention, only one terminal or two to five or more than six terminals 13 may also be provided. The terminals 13 each have a cylindrical, preferably ceramic insulating element, which encloses the particular pin-shaped, electrically conductive terminal in the area of the exit of the pin from the housing 10, for insulation in relation to the housing 10, which usually comprises a metallic material, e.g., stainless steel or titanium, on its surface.

As already described above, the housing 10 contains the batteries of the cardiac pacemaker and electronic devices.

The header 20 shown in FIG. 2 has receptacles 22, into which the rods 12 of the housing 10 may be inserted during mounting.

Six electrically conductive terminals 23, which are implemented as pin-shaped and project downward out of the header 20, are provided in the area of the lower, linear edge 21 of the header 20. These terminals are connected to the corresponding terminals 13 of the housing 10 during production of the cardiac pacemaker.

In addition, three short pins (rods) 24 are provided distributed over the entire length of the edge 21 on the edge 21, which are also used for mounting the header 20 on the housing 10. The rods 12 and the pins 24 may also be referred to as anchor pins and/or fixing aids.

The header 20 also has a shoulder 27, on an approximately oval line enclosing the two plug receptacles 25, which is used for fastening the correspondingly shaped cover 30 to cover the plug receptacles 25. The shoulder 27 preferably has an undercut for this purpose.

Openings 26 for air to escape from the header and a continuous, circular recess 28, which is used for sewing the cardiac pacemaker into the body of the patient, are provided on the header 20 in the area of its left and right lower corners. In addition, a marking for recognizing the cardiac pacemaker using x-ray radiation may be provided on the header 20.

In further exemplary embodiments, the header 28 may only have one plug receptacle 25 or more than two plug receptacles 25 as needed. The shape of the shoulder 27 and thus the shape of the corresponding cover 30 are designed in accordance with the number of the plug receptacles 25. In further exemplary embodiments, for example, two plug receptacles 25 may be combined and enclosed by one shoulder 27 and correspondingly covered by a cover 30.

The header 20 has six terminals 23 in the exemplary embodiment shown in FIG. 2. In further exemplary embodiments, the header 20 may also only have one terminal 23 or another arbitrary number of terminals 23.

The surface of the header 20 preferably comprises polyurethane, polycarbonate, polyester, polyether, or polyolefin, in particular polyethylene and polypropylene, polyvinyl chloride (PVC) or polystyrene.

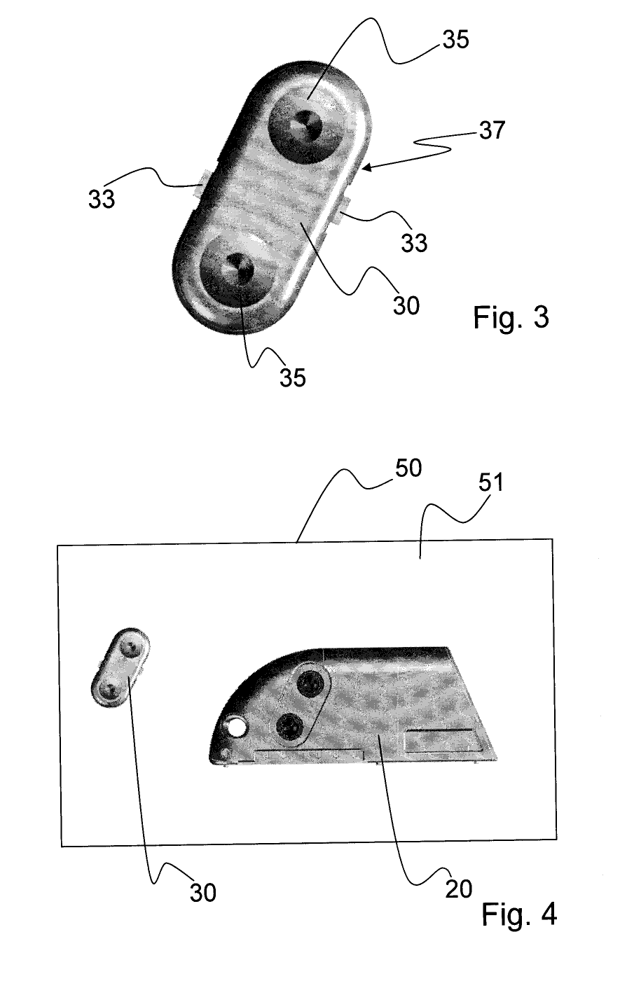

The cover 30 shown in FIG. 3 is used for covering the two plug receptacles 25 of the header 20. For this purpose, the cover 30 has two circular molded areas 35, in which a slot is provided centrally, through which the plug (not shown) of the particular electrode may be plugged into the particular plug receptacle lying underneath. The connection between electrode plug and plug receptacle 25 is thus sealed.

The cover has a tab 33 laterally on each of the longitudinal sides of the border 37, which is used for mounting the cover 30 on the header 20. The border 37 enclosing the cover 30 is designed in such a way that it may be fastened to the shoulder 27 of the header 20. The border 37 preferably has an undercut for this purpose.

The surface of the cover 30 preferably comprises polyurethane, polycarbonate, polyester, or polyether, polyolefin, in particular polyethylene and polypropylene, polyvinyl chloride (PVC), or polystyrene.

Sealing elements, preferably sealing lips, may be provided on the header 20 in the area of the shoulder 27 and/or on the cover 30 in the area of the border 37, which are additionally used for sealing header 20 and cover 30 in this area.

After each of the elements housing 10, header 20, and cover 30 has been manufactured per se, the three elements are now to be assembled into a cardiac pacemaker.

For this purpose, in a first exemplary embodiment of the production method according to the present invention (activation procedure 01), header 20 and cover 30 are firstly situated separately in a device 50 for plasma activation to activate the surfaces of header 20 and cover 30 in a plasma activation step. The plasma activation device 50 schematically illustrated in FIG. 4 completely receives the header 20 and the cover 30 for this purpose. A plasma 51, which encloses the elements header 20 and cover 30, is situated between two electrodes (cathode and anode) (not shown) in the interior of the plasma activation device.

Because the generation of a plasma is known per se, it will not be discussed in greater detail in the following.

A low-pressure plasma or a normal-pressure plasma (plasma generated at atmospheric pressure) is generated in the device 50, at least one element or one compound of the group oxygen, hydrogen, argon, nitrogen, ammonia, and fluorine preferably being contained in the plasma. The plasma is preferably driven at a frequency of approximately 5 kHz to approximately 100 kHz or a frequency of 13.56 MHz or 2.45 GHz. The plasma preferably outputs a power of 1 W to approximately 1000 W. The treatment time of the header 20 and the cover 30 in the plasma can be approximately 10 seconds to approximately 30 minutes.

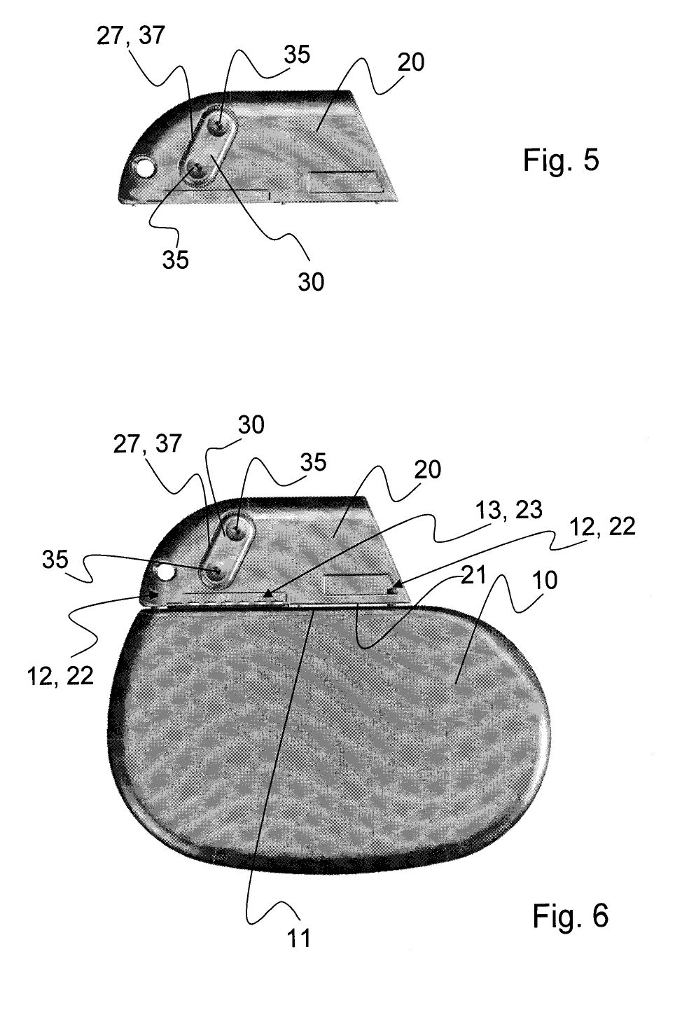

After header 20 and cover 30 have been treated in the plasma activation step, the cover 30 is mounted on the header 20, i.e., the tabs 33 of the cover 30 are situated in corresponding openings of the header 20. The cover 30 is subsequently glued to the header 20, an adhesive being placed along the shoulder 27 and/or the border 37 for this purpose. The adhesive, preferably epoxide resin or silicon, generates a permanent bond between cover 30 and header 20 on one hand and seals the area between header 20 and cover 30 on the other hand. In the gluing step, it is to be ensured that this joining step is started at earliest approximately 15 seconds to at latest approximately 300 minutes after the plasma activation step. The resulting unit made of header 20, which is glued to the cover 30, is shown in FIG. 5.

Subsequently, the header 20 provided with the cover 30 is placed having its lower edge 21 on the upper edge 11 of the housing 10 and mounted in such a way that the pins 24 of the header 20 are situated in corresponding receptacles of the housing 10 and each rod 12 of the housing 10 is situated in the corresponding receptacle 22 of the header 20. In addition, each terminal 13 of the housing 10 is welded to a corresponding, diametrically opposite terminal 23 of the header 20. The state after mounting of the header 20 glued to the cover 30 on the housing 10 and the welding of the terminals 13, 23 is shown in FIG. 6. The cover 30, the header 20, and the housing 10 form a unit which may no longer be separated without further measures.

After the welding and the mounting of header 20 and housing 10, these elements are glued to one another. For this purpose, an adhesive, preferably epoxide resin or silicone, is situated in the area of the intermediate space between the edges 11, 21 in such a way that the adhesive closes the intermediate space. In addition, the connected terminals 13, 23 are covered and the connected terminals 13, 23 adjacent to one another are insulated from one another by the adhesive. The adhesive is additionally introduced in such a way that it penetrates into the header 20 and exits outward to the openings 26. It is thus ensured that the adhesive has propagated as desired completely in the area of the edges 11, 21 and the terminals 13, 23 and/or into the lower area of the header 20 and the desired seal has been achieved in this area. The production of the cardiac pacemaker according to the first exemplary embodiment of the present invention is thus ended.

In a second preferred exemplary embodiment (activation procedure 03), header 20 and cover 30 may also be connected to one another in that they are first mounted on one another and subsequently plasma activated jointly in this mounted state. Subsequently, they are glued. The method for connecting the header 20 to the housing 10 runs similarly to the first exemplary embodiment.

In a third preferred exemplary embodiment of the method according to the present invention (activation procedure 02), the header 20, after separate plasma activation of header 20 and cover 30, may also firstly be mounted as described above on the housing 10. Subsequently, as described above, the terminals 13, 23 of housing 10 and header 20 are welded to one another and header 20 and housing 10 are glued to one another as described above. In a further method step, the plasma-activated cover 30 is mounted as described above on the header 20 and plasma activated once again together with the housing 10 already glued to the header 20 in the plasma activation device 50. After completed plasma activation, cover 30 and header 20 are glued as described above.

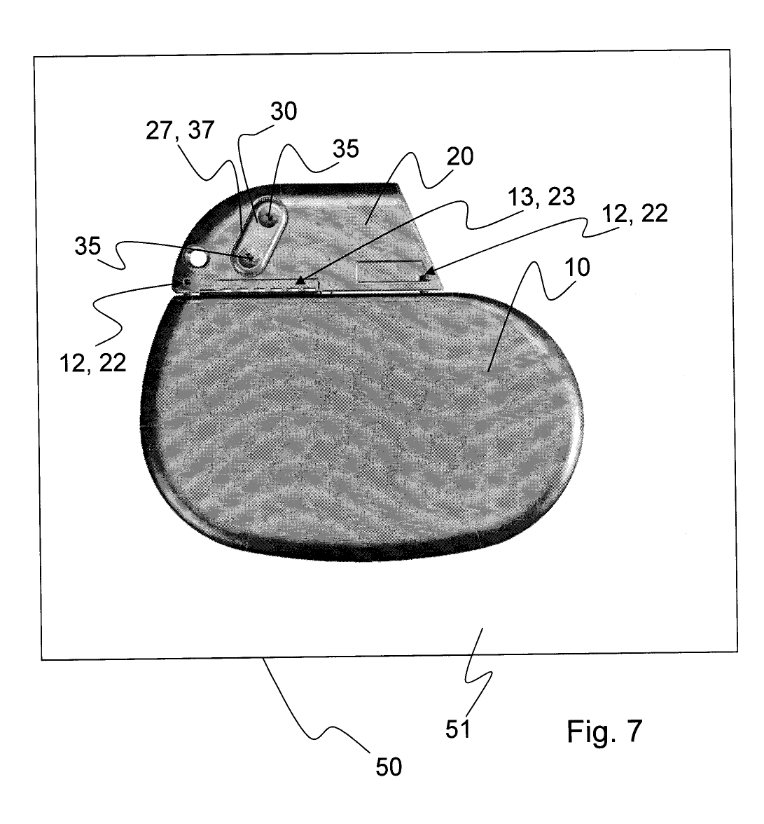

In a fourth exemplary embodiment (activation procedure 04) of a method according to the present invention, firstly header 20 and cover 30 are mounted as described above and plasma activated jointly as a unit in the mounted state. Subsequently, header 20 and cover 30 are glued to one another as described above. In a following step, the header 20 provided with the cover 30 is mounted on the housing 10 as described above and the terminals 13, 23 of housing 10 and header 20 are welded. In this state, this unit, which has the elements header 20 and cover 30 glued to one another, the housing 10 mounted with the header 20, and welded terminals 13, 23, is subjected to a further plasma activation step, which is illustrated in FIG. 7. This figure shows the configuration of the cited unit in the device 50 for plasma activation.

The device for plasma activation 50 shown in FIG. 7 corresponds to the device 50 shown in FIG. 4 in regard to its properties cited in connection with FIG. 4. Because the unit made of the elements housing 10, header 20, and cover 30 has larger dimensions than header 20 and cover 30 separately, it is only necessary to provide the interior of the device for plasma activation in a corresponding size.

After the plasma activation illustrated in FIG. 7, header 20 and housing 10 are glued to one another as described above.

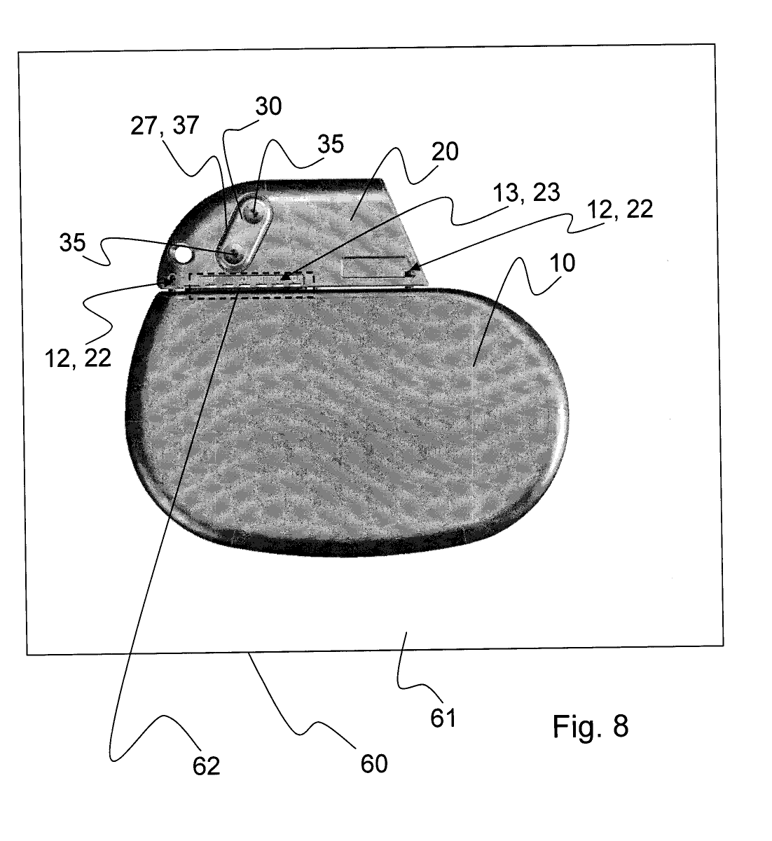

In a fifth preferred exemplary embodiment (activation procedure 05), which is performed similarly to the fourth exemplary embodiment, a plasma cleaning step, which is schematically shown in FIG. 8, may additionally be provided before a plasma activation of header 20 and housing 10 mounted one on another, which also have already welded terminals 13, 23.

FIG. 8 shows the unit constructed similarly to the unit from FIG. 7 having header 20 with glued cover 30 and housing 10 mounted on the header, the terminals 13, 23 already having been welded to one another, in the device 60 for plasma cleaning. The device 60 has a plasma 61 for plasma cleaning. The unit made of header 20, housing 10, and cover 30 is cleaned in a plasma generated at atmospheric pressure (normal-pressure plasma) in the area 62 of the terminals 13, 23 welded to one another. This means that soot arising during the welding of the terminals 13, 23, for example, is removed by the plasma cleaning and transported away from the unit. The plasma contained in the device 60 preferably contains oxygen and/or fluorine. The plasma cleaning treatment in the area 62 lasts approximately 12 minutes at most. The plasma 61 situated in the device 60 is preferably driven at a frequency of 27.2 MHz or at a frequency of 2.45 GHz.

As described in the fourth exemplary embodiment, the production method is continued after the cleaning in the plasma cleaning step with the plasma activation and the gluing of header 20 and housing 10.

In a sixth exemplary embodiment (activation procedure 06), the further plasma activation step performed after the plasma cleaning in the fifth exemplary embodiment may also be left out. Furthermore, the mounting and gluing of header 20 and cover 30 may first be performed after the gluing of header 20 and housing 10.

In a seventh exemplary embodiment (activation procedure 07 without plasma cleaning), the cover 30 may also be mounted on the header 20 and the header 20 provided with the mounted cover may be mounted on the housing 10. Subsequently, the terminals 13, 23 of header 20 and housing 10 are welded to one another. The unit made of cover 30, header 20, and housing 10 thus mounted and welded is subsequently jointly subjected to a plasma activation step. Subsequently, as described above, housing 10 and header 20 are glued to one another and cover 30 and header 20 are glued to one another.

In an eighth exemplary embodiment (activation procedure 07), which is otherwise performed similarly to the seventh exemplary embodiment, the area 62 of the welded terminals 13, 23 may be subjected to a plasma cleaning step, as described above in connection with the fifth exemplary embodiment, after the welding and before the plasma activation.

The invention is not intended to be limited to the preferred versions of the invention described above, but rather is intended to be limited only by the claims set out below. Thus, the invention encompasses all different versions that fall literally or equivalently within the scope of these claims.

What is claimed is:

1. A method for producing a medical implant from a first element and a second element, which each have a connection surface, the method including the steps of:
a. activating the connection surfaces of the first element and second element by subjecting the connection surfaces to plasma at or below atmospheric pressure;
b. joining at least a portion of the connection surface of the first element to at least a portion of the connection surface of the second element.

2. The method of claim 1 wherein each of the connection surfaces is at least partially formed of one or more of:
a. a plastic selected from one or more polymers of the group polyurethane, polycarbonate, polyester, polyether, polyolefin, and epoxide resin;
b. a metallic material selected from one or more of the group titanium, aluminum, stainless steel, cobalt_nickel alloy, silver, gold, platinum, iridium, and niobium;
c. a ceramic material.

3. The method of claim 1 wherein the joining step includes gluing at least a portion of the connection surface of the first element to at least a portion of the connection surface of the second element.

4. The method of claim 1 wherein the first element and the second element are welded to one another before the activation step and the joining step.

5. The method of claim 1 wherein the activation step is performed in a plasma which contains at least one element or one compound of the group oxygen, hydrogen, argon, nitrogen, ammonia, and fluorine.

6. The method of claim 1 wherein the plasma of the activation step is driven at a frequency of:
a. approximately 5 kHz to approximately 100 kHz, or
b. at or near 13.56 MHz, or
c. at or near 2.45 GHz.

7. The method of claim 1 wherein the plasma of the activation step is driven at a power of approximately 1 W to approximately 1000 W.

8. The method of claim 1 wherein the connection surfaces are subjected to plasma for approximately 10 seconds to approximately 30 minutes.

9. The method of claim 1 wherein the joining step is started between:
a. approximately 15 seconds, to
b. approximately 300 minutes,
after the plasma activation step.

10. The method of claim 1 further including a cleaning step prior to the activation step, wherein at least a portion of one or more of:
a. the connection surface of the first element, and
b. the connection surface of the second element,
is cleaned by plasma at or below atmospheric pressure.

11. The method of claim 10 wherein the cleaning step utilizes plasma which contains oxygen and/or fluorine.

12. The method of claim 11 wherein the cleaning step lasts no more than approximately 15 minutes.

13. The method of claim 10 wherein the plasma of the cleaning step is driven at a frequency:
a. at or near 27.2 MHz, or
b. at or near 2.45 GHz.

14. The method of claim 1 wherein:
a. the first element is the header, and
b. the second element is one or more of:
(1) the housing, and
(2) the cover,
of a cardiac pacemaker or defibrillator.

15. The method of claim 1 wherein:
a. the first element is the header of a cardiac pacemaker or defibrillator,
b. the first element is the cover of a cardiac pacemaker or defibrillator,
c. the header and the cover are each subjected to the activation step,
d. the header and the cover are subsequently glued to one another in a first joining step,
e. the glued header and cover are subsequently mounted on a housing of a cardiac pacemaker or defibrillator,
f. terminals of the housing are subsequently welded to terminals of the header,
g. the housing and the header are subsequently glued to one another in a second joining step.

16. The method of claim 15 wherein the terminals of the housing and the terminals of the header are each subjected to a plasma cleaning step prior to being welded.

17. The method of claim 1 wherein:
a. the first element is the header of a cardiac pacemaker or defibrillator,
b. the first element is the cover of a cardiac pacemaker or defibrillator,
c. the header and the cover are mounted to each other,
d. the header and the cover are together subsequently subjected to the activation step,
e. the header and the cover are subsequently glued to one another in a first joining step,
f. the header and the cover are subsequently mounted on a housing of a cardiac pacemaker or defibrillator,
g. terminals of the housing are subsequently welded to terminals of the header,
h. the housing and the header are subsequently glued to one another in a second joining step.

18. The method of claim 17 wherein the terminals of the housing and the terminals of the header are each subjected to a plasma cleaning step prior to being welded.

19. The method of claim 1 wherein:
a. the first element is the header of a cardiac pacemaker or defibrillator,
b. the first element is the cover of a cardiac pacemaker or defibrillator,
c. the header and the cover are mounted to each other,
d. the header and the cover are subsequently glued to one another in a first joining step,
e. the header and the cover are subsequently mounted on a housing of a cardiac pacemaker or defibrillator,
f. terminals of the housing are subsequently welded to terminals of the header,
g. the header, housing, and cover are together subsequently subjected to the activation step,
h. the housing and the header are subsequently glued to one another in a second joining step.

20. The method of claim 19 wherein the terminals of the housing and the terminals of the header are each subjected to a plasma cleaning step prior to being welded.
